(19) United States
(12) Patent Application Publication
(10) Pub. No.: US 2004/0223670 A1
(43) Pub. Date: Nov. 11, 2004

(54) Linear movement guide

(75) Inventors: Lutz Ramonat, Langenthal (CH); Hans-Martin Schneeberger, Langenthal (CH); Ernst Mischler, Roggwil (CH); Hans Egger, Sins (CH)

Correspondence Address: VENABLE, BAETJER, HOWARD AND CIVILETTI, LLP, P.O. BOX 34385, WASHINGTON, DC, 20043-9998, US

(73) Assignee: Schneeberger Holding AG, Roggwil (CH)

(21) Appl. No.: 10/797,569

(22) Filed: Mar. 11, 2004

(30) Foreign Application Priority Data
Mar. 13, 2003 (CH) CH 0406/03

(51) Int. Cl. B23K 11/30; B23K 1/16; F16C 29/06

(52) U.S. Cl. 384/45

(57) ABSTRACT

A linear movement guide for translatory relative movement, without lubricants, of objects to be moved along a guide axis (1) comprises a rail (2) on which at least one carrying surface (10), which extends parallel to the guide axis, is provided, and a carriage (8) which comprises at least one loop (9, 45) of roller bodies, wherein the loop (9, 45) of roller bodies is a closed loop for the circulation of roller bodies. The roller bodies, which are arranged in the loop (9, 45) of roller bodies of the carriage (8), during a relative movement between the carriage (8) and the rail (2), for the transfer of loads, run through a carrying area of the loop of roller bodies and in this process are positioned both against the carrying surface (10) of the rail (2) and against the carriage (8), at least essentially free of any organic lubricants. At least some of the roller bodies comprise two or more different materials with which in the roller bodies a core (17) as well as, for the purpose of creating a contact surface (19) between the respective roller body and the rail, a zone which surrounds the core (17) is formed. Moreover, the linear movement guide comprises several separating-elements (21, 31, 41) which in the loop (9, 45) of roller bodies are arranged between two roller bodies for preventing any contact between the two respective roller bodies.

### FIELD OF THE INVENTION

The invention relates to a linear movement guide for linear relative movement of objects to be moved along a guide axis, comprising a rail on which at least one carrying surface, which extends parallel to the guide axis, is provided; a carriage which comprises at least one loop of roller bodies, in which loop roller bodies are arranged, wherein the loop of roller bodies is a closed loop for the circulation of the roller bodies, wherein the roller bodies, which are arranged in the loop of roller bodies of the carriage, during a relative movement between the carriage and the rail, for the transfer of loads, run through a carrying area of the loop of roller bodies and in this process are positioned both against the carrying surface of the rail and against the carriage.

### BACKGROUND OF THE INVENTION

Linear guides for roller bearings are used in many areas of technology in which one component is to be moved in a straight line relative to another component, as far as possible without friction loss. Machine tools are just one example of this. Such guides comprise a carriage or slide as a guide body, with said guide body being guided along a rail by way of roller bodies such as balls, rollers or needles. In this arrangement, the roller bodies circulate in loops of roller bodies of the carriage, which loops are closed per se. Normally, the guiding bodies comprise a carrying area in which the roller bodies rest against a carrying surface of the carriage and against the rail, and as a result of this carry the load to be moved. As a result of the linear movement of the carriage, the roller bodies move from the carrying zone into a first deflection channel, in which the roller bodies are transferred from the carrying zone to the return channel. After passing through the return channel, the roller bodies return to the carrying zone by way of a second deflection channel.

Balls or rollers (e.g. cylinder rollers, barrel rollers or tapered rollers as well as needles) are used as roller bodies. In most cases by far, the rails and roller bodies of roller bearings are made from roller bearing steel. It has been shown that the strength and rigidity of non-metal roller bodies, in particular balls made of ceramic material, are comparable to or even better than those made of roller bearing steel, thus making it possible to construct high-precision bearings. However, ceramic balls are associated with a disadvantage in that their elasticity is poor. With accordingly unfavourable loads, such balls tend to become damaged.

Lubrication of roller bearings is provided to reduce friction between roller bodies and running paths, so that the friction between the components of a roller bearing and thus also their wear can be minimised. In addition, grease is provided to seal the bearing off against dirt penetration from the outside. Lubricants are also used as corrosion protection for installed bearings. Roller bearing seals are intended to hold the lubricant in the roller bearing and prevent any ingress of impurities. In linear bearings, strippers are usually provided on both ends, with said strippers keeping dirt particles away from the bearings.

The supply of lubricant as well as re-lubrication are governed by the respective operating conditions. Among other things, for example, encapsulated bearings (sealed bearings) are known whose lubricant supply lasts for the entire life of the bearing. However, in the case of bearings with a rather long service life, a continuous or intermittent supply of lubricant is required in order to make up for losses, for example on seals or strippers. Such losses occur because the unrolling movement of the roller bodies forms a thin lubricant film in particular on the running surfaces of rails. In the case of linear roller bearings, which is different from the situation with radial bearings where the lubricant is located in a closed loop, there is a discharge of lubricants from the region of the carriage. As a rule, the strippers provided at the front and rear of the carriage cannot completely wipe the lubricant off the running surfaces. As a result of this continuous loss of lubricant, the cycle for relubrication is shortened, in other words lubrication for life is made considerably more difficult. However, relubrication, in particular in the case of production machines, is tantamount to non-productive service time and most of the time also requires additional personnel. Moreover, relubrication often requires special equipment such as e.g. centralised lubrication equipment and similar. Last but not least, lubricants are also associated with additional costs and with an ecological burden.

In the context of linear movement guides, too, so-called cages for roller bodies have become known. As a rule they serve to hold the roller bodies at even spacing from each other so as to achieve noise minimisation and/or so as to keep the displacement forces of the roller bodies as constant as possible. Furthermore, cages can facilitate the installation of the linear movement guide because said cages keep the roller bodies together as an assembly component.

### SUMMARY OF THE INVENTION

It is thus the object of the invention to provide a linear movement guide which with the least possible lubrication expenditure achieves a long service life. In this context, linear movement guides are to be provided which can be used in applications where normally no liquid lubricant, in particular no organic lubricant, can be used.

In a linear movement guide according to the invention, this object is met by a linear movement guide for translatory relative movement of objects to be moved along a guide axis, comprising a rail on which at least one carrying surface, which extends parallel to the guide axis, is provided; a carriage which comprises at least one loop of roller bodies, wherein the loop of roller bodies is a closed loop for the circulation of roller bodies, wherein the roller bodies, which are arranged in the loop of roller bodies of the carriage, during a relative movement between the carriage and the rail, for the transfer of loads, run through a carrying area of the loop of roller bodies and in this process are positioned both against the carrying surface of the rail and against the carriage, at least essentially free of any organic lubricants, wherein at least some of the roller bodies comprise two or more different materials with which in the roller bodies a core as well as, for the purpose of creating a contact surface between the respective roller body and the rail, a zone which surrounds the core is formed, wherein the material, of which there is at least one, of the contact surfaces of the roller bodies differs from the material, of which there is at least one, of which the running surface of the rail is made, as well as comprising several separating-elements which in the loop of roller bodies are arranged between two roller bodies for preventing any contact between the two respective roller bodies.

In the case of linear movement guides which are scarcely supplied, or not supplied at all, with organic lubricants, there is always the danger of cold welding occurring between the roller bodies and the running rail, as a result of which a guide can be destroyed, or at least significantly damaged. While in the case of conventional linear movement guides this danger can be reduced by using dry lubricant, the danger can nevertheless not be avoided permanently. Surprisingly, it has been shown that this danger of cold welding occurring can be very significantly reduced by using separating means between roller bodies, in combination with roller bodies which in each instance comprise at least two different materials. Any occurrence of cold welding can be further prevented if the materials used in the running surfaces of the rails, and the materials used for constructing the contact surfaces of the roller bodies differ from each other. The same applies to the materials of the surfaces on the carriages, with which surfaces the roller bodies establish contact, as well as the materials of the contact surfaces of the roller bodies. These materials, too, should preferably differ from each other and should be matched to each other so that as far as possible they do not allow cold welding to occur. The simplest way of achieving this consists of ensuring that only one of the materials is a metal, in particular a steel.

It is thus possible, even without the use of organic lubricants, to extend the service life of a guide to an extent which in the case of conventional pure steel bearings can only be achieved with such organic lubricants. The invention allows in particular the construction of non-outgassing linear movement guides which provide extended service life cycles, which linear movement guides are eminently suitable for application in the area of vacuum technology, clean room technology or in areas where specified atmospheric conditions have to be met.

In a preferred embodiment, the roller bodies can comprise a core which comprises a material that is more elastic than the material used in an outer region of the roller bodies. Preferably, this outer region, which forms the contact surfaces of the roller bodies, comprises a material which does not tend to cold welding with the material of the running surfaces of the rail, and preferably also does not tend to cold welding with the material of the carriage. Since normally roller bearing steel is used for rails, ceramic materials, hard materials and materials containing dry lubricants can, for example, usually be considered for the outer layer.

For the zone which surrounds the core, materials such as for example graphite-like or adamantine carbon, tungsten carbide, titanium carbide, silicon nitride, chromium compounds, tungsten disulphide and/or molybdenum disulphide can be used.

For the core which is preferably more elastic when compared to the surrounding zone, roller bearing steel can be considered for example. The softer or more elastic core, when compared to the outer layer of the balls, allows at least some slight elastic deformation of the roller bodies, without said deformation necessarily leading to damage of the roller bodies. In addition, this elasticity makes it possible to provide a larger contact area, compared to pure ceramic roller bodies, between the running surfaces of the rail and the roller bodies. To this effect, surface pressure can be reduced which in turn leads to a significant increase in the service life of the guide. According to the invention, the materials among the roller bodies and in relation to the material of the rail can be matched to each other.

Surprisingly, it has been shown that separating-elements between the roller bodies, too, contribute to an increase in the service life. This is surprising because separating-elements between the roller bodies lead to a reduction in the number of load-bearing roller bodies. This in turn results in a smaller number of load-bearing roller bodies having to absorb the load, which one would expect to lead to an increase in wear of the roller bodies and thus a reduction of the service life. This applies in particular in view of the preferably complete absence of organic lubricants such as oils and similar. Contrary to these expectations, however, dry-running linear movement guides with separating-elements between two-component or multi-component roller bodies have shown to provide a completely adequate service life. In particular, destruction of the surface of the roller bodies as a result of friction between adjacent roller bodies can be safely prevented with such an arrangement.

In a preferred embodiment of the invention, the separating-elements can be a component of a so-called chain of roller bodies and can thus be connected to each other. By contrast, in an alternative embodiment, the separating-elements are constructed as structural elements, each of which runs along between two roller bodies, which structural elements are independent of other separating-elements.

An improvement according to the invention can provide for separating-elements which move along with the roller bodies essentially only in a translatory sense. These separating-elements can comprise spacer rotary bodies which are arranged in the separating-elements so as to be freely rotatable. The spacer rotary bodies can establish contact with both roller bodies between which the respective separating-element is arranged. By way of friction, the rotary movement of these two roller bodies also causes the spacer rotary body to rotate.

This preferred embodiment according to the invention makes it possible to achieve as small a contact area as possible between the roller bodies and the separating-elements, namely their spacer rotary bodies. Furthermore, between the spacer rotary bodies and the roller bodies which lock said spacer rotary bodies in between themselves, there is approximately a movement in which all contact partners undergo rotary movement. In this arrangement, the spacer ball can be driven as a result of the rotary movement of both roller bodies between which said spacer ball is arranged. These are essentially roller contacts which are particularly low in friction. Furthermore, there is an advantage in that the spacer ball needs to establish contact neither with the rail nor with the carriage; contact which would mean additional friction. Overall, it is thus possible to achieve a high-quality guide arrangement of the roller bodies in which at the same time friction is very low.

Further preferred embodiments of the invention result from the dependent claims.

The invention is explained in more detailed by means of the diagrammatic embodiments shown in the figures; with the following being shown:

### BRIEF DESCRIPTION OF THE DRAWINGS

FIG. 1 a perspective view of a linear movement guide with a carriage in partially broken-off view;

FIG. 2 a longitudinal section of the carriage shown in FIG. 1 in the region of a carrying zone;

FIG. 3 a section view of a roller body;

FIG. 4 a second embodiment of a linear movement guide in a perspective in-principle diagram according to FIG. 1;

FIG. 5 a section view of a detail from FIG. 4;

FIG. 6 a section of a loop of roller bodies with a further embodiment of the separating-elements; and

FIG. 7 a further embodiment of separating-elements in a view according to that of FIG. 6.

### DETAILED DESCRIPTION OF THE PREFERRED EMBODIMENTS

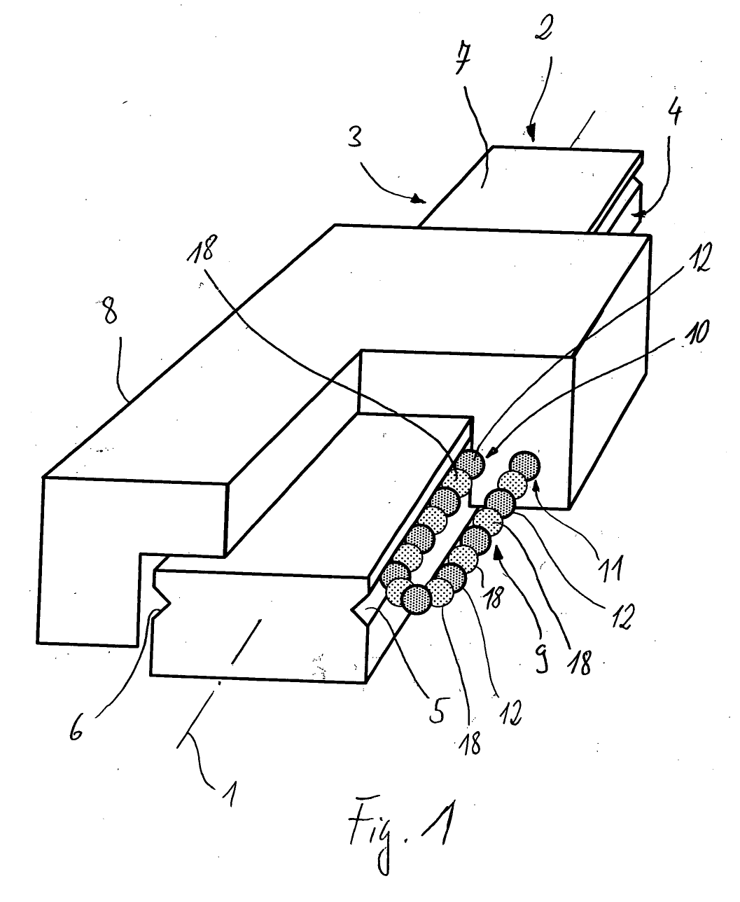

The linear movement guide shown in FIG. 1 comprises a rail 2 which extends in a straight line along a guide axis 1, with the two longitudinal sides 3, 4 of said linear movement guide by a specified profile shape comprising at least one running surface 5, 6. The top 7 of the rail 2 is essentially flat.

Arranged on the rail 2 is a carriage 8 which can be slid along the guide axis 1. The carriage 8, which is U-shaped in cross-section, can be a basic body made of metal with end caps (not shown in detail) on both ends. The basic body and the two end caps together form two loops of roller bodies 9 in the shape of closed-loop channels. To this effect, the basic body, on the inside of each limb of the U-shape, comprises two carrying surfaces 10, which extend parallel to the guide axis 1, with each of said carrying surfaces being arranged opposite one of the running surfaces 5, 6 of the rail 2. The carrying surfaces 10 form a carrying area of the carriage, in which roller bodies rest against both the carrying surface 10 and the rail 2 and are thus able to transmit loads from the carriage 8 to the rail 2 and vice-versa. A recess in the basic body, which recess extends parallel to the carrying surface 10, serves as a return channel-11 of the loop 9 of roller bodies.

In each of the end caps (not shown in detail) for each loop 9 of roller bodies, there is a return channel, for example of approximately semicircular shape, with said return channel connecting the respective carrying area to the return channel. The roller bodies, which in the embodiment are balls 12, are thus in a closed loop and, by way of the deflection channels, can circulate between the carrying area and the return channel of each loop 9 of roller bodies.

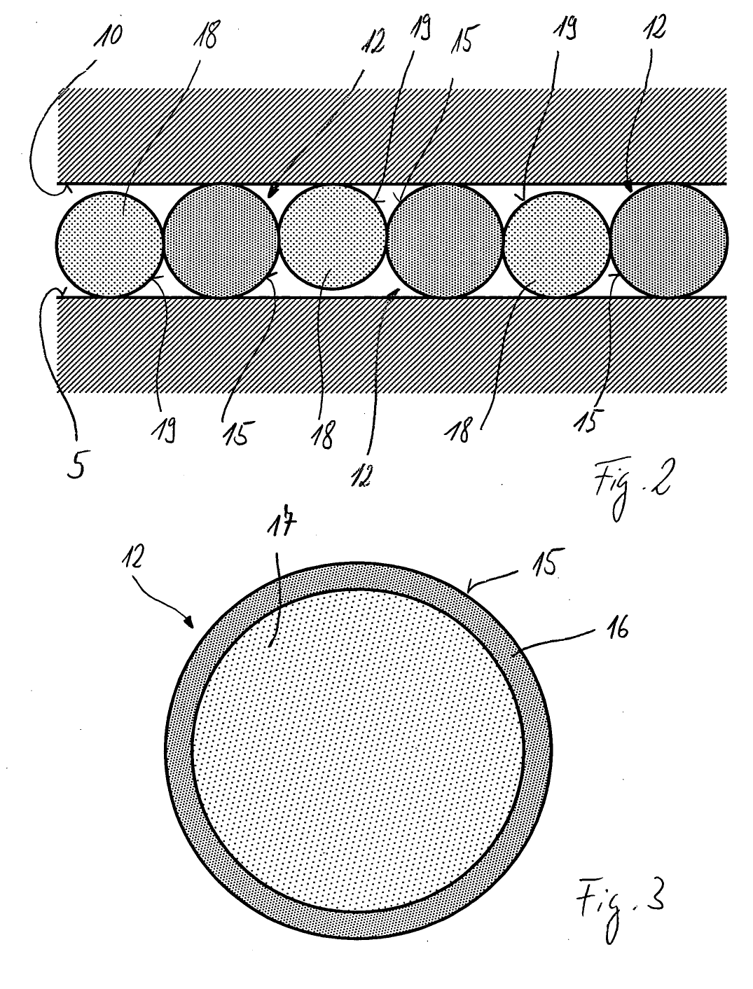

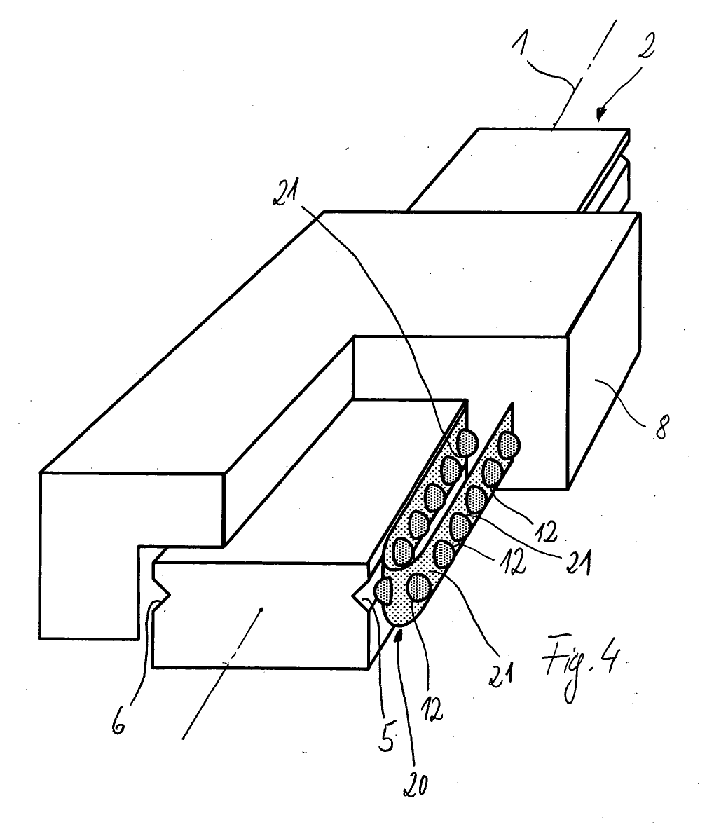

FIG. 2 shows a partial section of a linear roller bearing according to a first embodiment of the invention. Between the running surface 5 and the carrying surface 10, balls 12 are arranged whose contact surfaces 15 establish contact with the surfaces 5, 10. In this case, the running surface 5 consists entirely of roller bearing steel. Alternative embodiments of the running surfaces comprise e.g. case hardened steels or manganese-silicon steels. The roller body, which in FIG. 3 is shown in a sectional view and which is designed as a ball 12, comprises an outer layer 16 made of adamantine carbon which forms particularly hard surfaces or contact surfaces 15.

A core 17 of the roller bodies can be made of roller bearing steel. Stainless or non-stainless steel can be provided as a roller bearing steel. Examples of this are the steels with materials numbers 1.4112 and 1.3505. For coating, which should be as constant in thickness as possible, for example silicon nitride (Si₃N₄), tungsten carbide or titanium carbide can be used. The layer thickness can be approx. 0.1 μm to 20 μm, preferably 0.3 μm to 5 μm.

As shown in FIG. 1, in each case a separating-element in the form of a so-called spacer roller body is provided between two load-bearing balls 12. In the embodiment shown, the spacer roller bodies are spacer balls 18. The spacer balls 18 can for example comprise PTFE. They can either be made entirely from this material or can comprise this material only on the surface or on their contact surface 19 as a layer. PTFE has the characteristics of not producing any cold welding, in particular with steels. Advantageously, the spacer balls 18 are smaller than the load-bearing (roller body) balls 12. Advantageously, the spacer roller bodies, which in an alternative embodiment can also be of cylindrical shape, are smaller, by a value of 1% to approx. 50% related to the diameter, than the respective load-bearing roller bodies between which said spacer roller bodies are arranged.

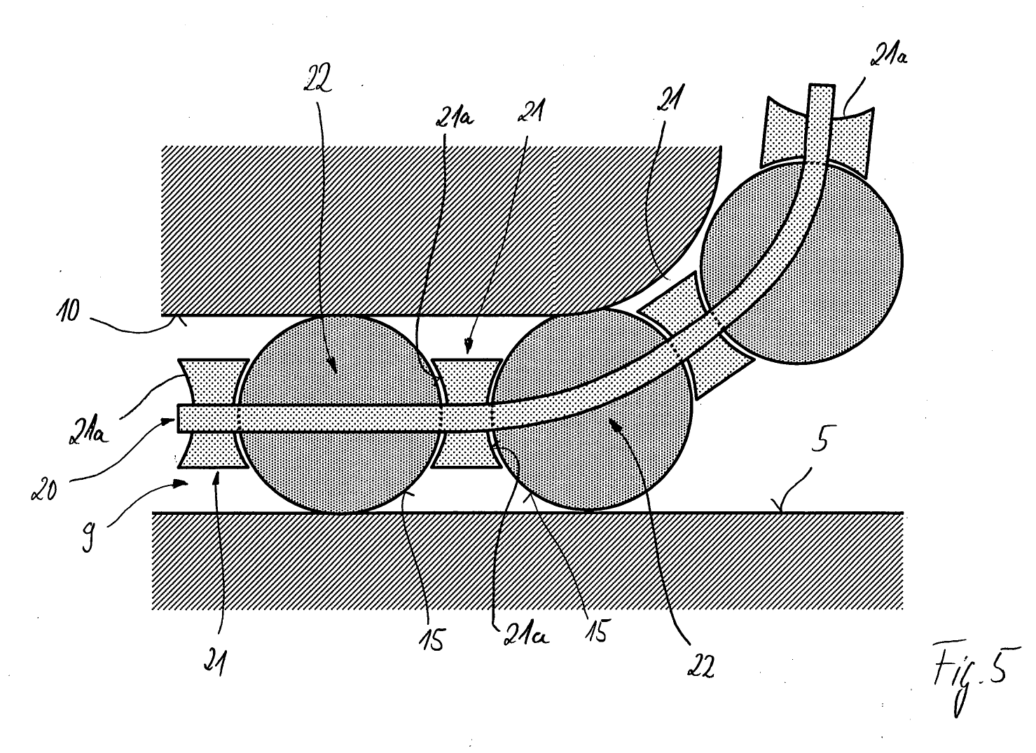

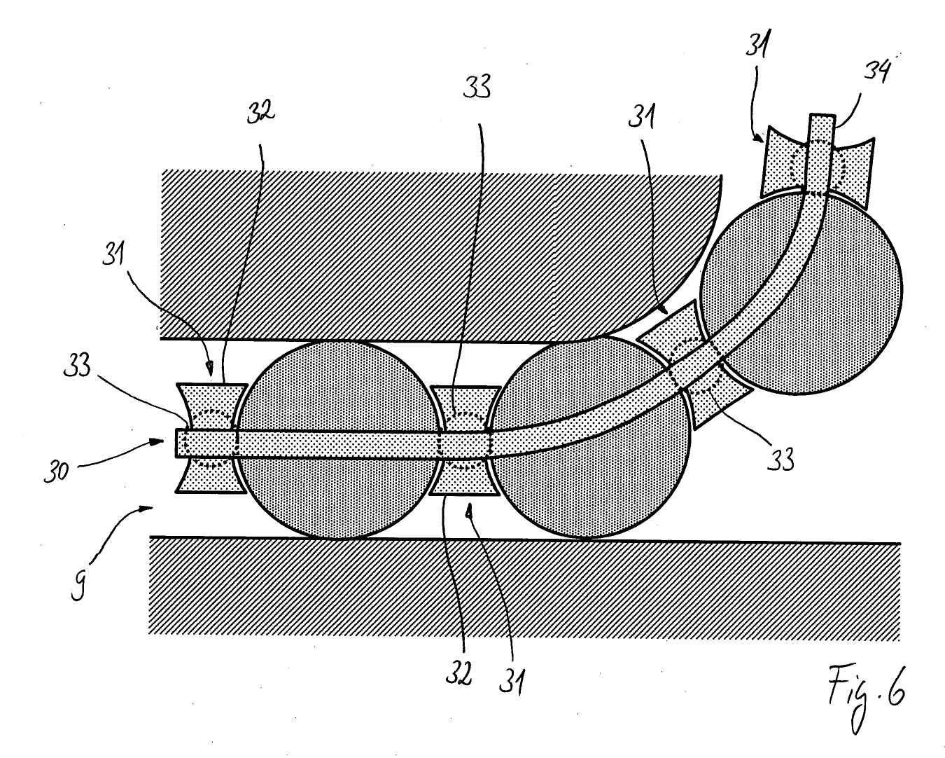

FIGS. 4 and 5 show a second embodiment of a linear roller bearing according to the invention. The rail 2 is again made of a metal material, e.g. roller bearing steel, case hardened steel or manganese-silicon steel. The roller bodies, which again are shaped as balls 12, comprise a core 17 made of metal, and an outer layer 16 made of tungsten carbide, of which the contact surface 15, too, is made. The materials of the running surfaces 5, 6 of the rail 2 and of the roller bodies again comprise a pairing of materials as provided according to the invention.

In the embodiment shown in FIGS. 4 and 5, the individual balls 12 are arranged in a closed-loop ball chain 20. As a result of the ball chain 20, in each instance two subsequent roller bodies are spaced apart from each other by a separating-element 21. Thus, the term separating-element 21 refers to the respective section of the part of the ball chain, which section is located between two roller bodies. The separating-elements 21 are thus interconnected by means of the ball chain 20. At their sides facing the roller bodies, the separating-elements 21 comprise concave surfaces 21a which are matched to the contact surfaces 15 of the balls 12. Consequently, two subsequent separating-elements 21 form a retainer 22 for guiding a roller body. The separating-elements 21 can be made from a material with the lowest possible coefficient of friction, such as for example PTFE or POM.

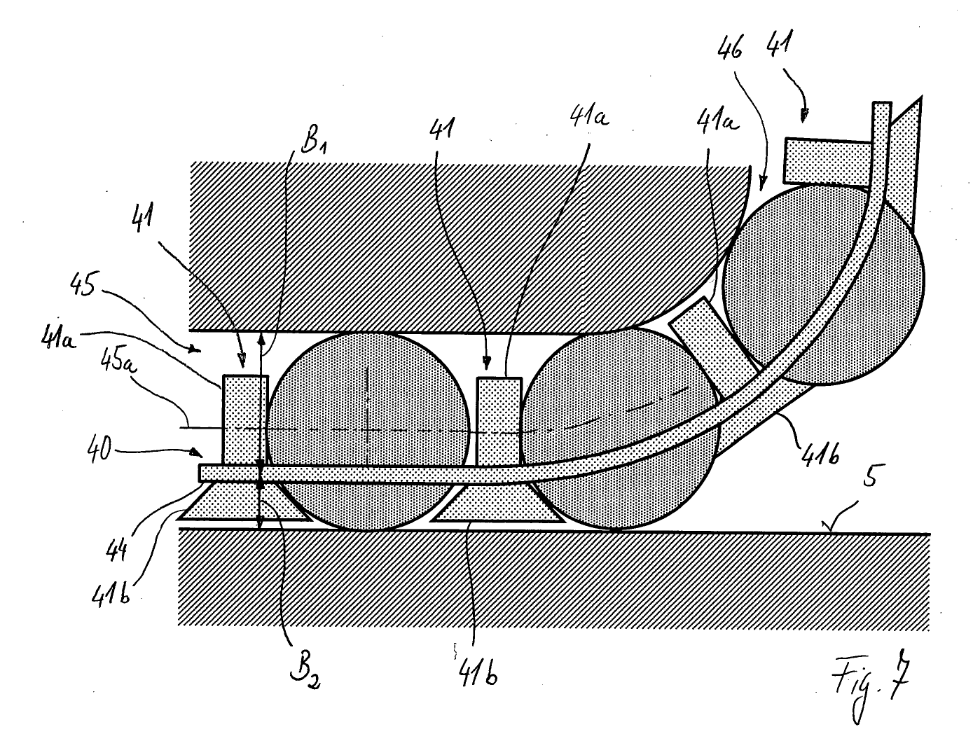

The further possible embodiment shown in FIG. 6 shows a section of a loop 9 of roller bodies, which loop comprises separating-elements 31. Apart from a spacer element 32 which moves exclusively in a translatory sense, the separating-elements 31 also comprise a spacer ball 33. Instead of a spacer ball 33, a spacer cylinder or a spacer roller could also be provided. The separating-elements 31 and spacer rotary bodies can comprise the above-mentioned materials. In this embodiment, too, the separating-elements form part of a ball chain 30 and are thus interconnected by an elastic ring element 34 which extends along the entire loop of roller bodies.

The geometric shape of the spacer elements 32 essentially corresponds to the shape of the separating-elements of the ball chain shown in FIGS. 4 and 5, similar to a doubly concave lens. Each spacer ball 33 is arranged in a recess of the spacer element 32 so as to be freely rotatable. In this arrangement, the spacer ball 33 is located between two roller bodies in such a way that its diameter is aligned flush with the diameter lines of the two roller bodies (in relation to the straight-line carrying area of the loop of roller bodies). As a result of the spacer ball 33 establishing contact with at least one of the two rotating roller bodies, the spacer ball 33, too, is made to rotate. Since both roller bodies drive the respective spacer ball 33 in the same direction, there is at least predominant roll friction if the spacer rotary body establishes contact with both roller bodies. In the embodiment shown, all roller bodies and spacer rotary bodies of the shown loop of roller bodies rotate on rotation axes which are situated in a common plane. In the example shown, this plane is aligned so as to be perpendicular to the plane of projection and extends through the centres of the roller bodies.

Unlike in the arrangement of the embodiment shown in FIG. 6, in the ball chain 40 shown in FIG. 7, the ring element 44 extends off-centre, i.e. eccentrically in relation to the centres of the balls 12 and thus also in relation to the width of the loop of roller bodies. In relation to a central circumferential line 45a of the loop 45 of roller bodies, the ring element is offset towards the running surface 5 of the rail. Thus, the ring element divides the loop of roller bodies into an area with a larger partial width B₁ and into an area of a partial width B₂ which is smaller when compared to B₁.

The separating-elements 41 which are diagrammatically shown in FIG. 7 comprise a section of narrower cross section 41a, which section is adjacent, in the region of the ring element, to a cone-shaped widened section 41b. The longitudinal extension of the separating-elements 41 extends across the direction of longitudinal movement of the roller bodies.

In a further embodiment (not shown), the separating-elements can additionally also comprise spacer balls, as shown in FIG. 6. Likewise, the separating-elements could comprise curved surfaces for contact with the roller bodies, as is for example the case in the separating-elements shown in FIG. 5.

As a result of the eccentric arrangement of the ball chain, the balls 12, in the region of deflection 46 on the side of the larger partial width B₁ of the loop 45 of roller bodies, are jammed between their two respective separating-elements. Due to the curvature of the ring element, the narrower rectangular sections 41a are conically tilted in relation to each other by following separating-elements. As a result of this, the sections 41a come to rest against the ball arranged between them, thus jamming this ball in. Due to the jamming action, the balls are subjected to a force component in the direction towards the cone-shaped sections 41b, onto which they are thus pushed. As a result of their external shape, the conical sections generate a type of grip from behind, thus contributing to the jamming of the balls between sections 41a and 41b of the separating-elements 41. The clamping action can thus be achieved based on an eccentric arrangement of the ring element and/or a suitable shape of the separating-elements.

Chains, as shown in FIG. 7, which exert a jamming action on the roller bodies have an independent significance of their own, irrespective of the selection of the materials for the roller bodies and the rail.

1. A linear movement guide for translatory relative movement of objects to be moved along a guide axis, comprising a rail on which at least one carrying surface, which extends parallel to the guide axis, is provided; a carriage which comprises at least one loop of roller bodies, wherein the loop of roller bodies is a closed loop for the circulation of roller bodies, wherein the roller bodies, which are arranged in the loop of roller bodies of the carriage, during a relative movement between the carriage and the rail, for the transfer of loads, run through a carrying area of the loop of roller bodies and in this process are positioned both against the carrying surface of the rail and against the carriage, at least essentially free of any organic lubricants, wherein at least some of the roller bodies comprise two or more different materials with which in the roller bodies a core as well as, for the purpose of creating a contact surface between the respective roller body and the rail, a zone which surrounds the core is formed, wherein the material, of which there is at least one, of the contact surfaces of the roller bodies differs from the material, of which there is at least one, of which the running surface of the rail is made, as well as comprising several separating-elements which in the loop of roller bodies are arranged between two roller bodies for preventing any contact between the two respective roller bodies.

2. The linear movement guide according to claim 1, wherein at least several, preferably all, separating-elements are interconnected.

3. The linear movement guide according to claim 1, wherein at least some of the separating-elements are arranged loosely between two roller bodies.

4. The linear movement guide according claim 1, wherein the core of the roller bodies is made of a metal material.

5. The linear movement guide according to claim 4, characterised in that the metal material is a roller bearing steel.

6. The linear movement guide according claim 1, wherein the zone surrounding the roller bodies comprises a hard material and/or dry lubricant.

7. The linear movement guide according to claim 6, wherein said zone surrounding the roller bodies comprises graphite-like or adamantine carbon, tungsten carbide, titanium carbide, silicon nitride, a chromium compound, tungsten disulphide and/or molybdenum disulphide.

8. The linear movement guide according to claim 6, wherein said zone surrounding the roller bodies comprises a ceramic material.

9. The linear movement guide according claim 1, wherein said lubricant is a dry lubricant.

10. The linear movement guide according to claim 6, wherein said dry lubricant comprises MoS₂, WS₂, graphite or PTFE.

11. A linear movement guide, in particular according to claim 1, comprising at least one separating-element which essentially moves along with the roller bodies in a translatory sense and which comprises a freely rotatable spacer rotary body.

12. A linear movement guide, in particular according to claim 11, wherein said the separating-elements form part of a ball chain and comprise a geometric shape as a result of which in the region of a deflection of the loop of roller bodies, jamming of the roller bodies occurs due to a curvature in the ball chain.
